(19) United States
(12) Patent Application Publication
(10) Pub. No.: US 2014/0218516 A1
(43) Pub. Date: Aug. 7, 2014

(54) METHOD AND APPARATUS FOR RECOGNIZING HUMAN INFORMATION

(71) Applicant: Electronics and Telecommunications Research Institute, Daejeon (KR)

(72) Inventors: Do-Hyung KIM, Daejeon (KR); Ho sub YOON, Daejeon (KR); Jae Yeon LEE, Daejeon (KR); Kyu-Dae BAN, Daejeon (KR); Woo han YUN, Daejeon (KR); Youngwoo YOON, Daejeon (KR); Jae Hong KIM, Daejeon (KR); Young-Jo CHO, Daejeon (KR); Suyoung CHI, Daejeon (KR); Kye Kyung KIM, Daejeon (KR)

(21) Appl. No.: 13/933,074

(22) Filed: Jul. 1, 2013

(30) Foreign Application Priority Data
Feb. 6, 2013 (KR) 10-2013-0013562

(51) Int. Cl. H04N 7/18

(52) U.S. Cl. CPC H04N 7/18
USPC 348/143

(57) ABSTRACT

A human information recognition method includes analyzing sensor data from multi-sensor resource placed in a recognition space to generate human information based on the sensor data, the human information including an identity, location and activity information of people existed in the recognition space. Further, the human information recognition method includes mixing the human information based on the sensor data with human information, the human information being acquired through interaction with the people existed in the recognition space; and storing a human model of the people existed in the recognition space depending on the mixed human information in a database unit.

### CROSS-REFERENCE TO RELATED APPLICATION(S)

The present invention claims priority of Korean Patent Application No. 10-2013-0013562, filed on Feb. 6, 2013, which is incorporated herein by reference.

### FIELD OF THE INVENTION

The present invention relates to an apparatus and method for recognizing human information, and more particularly, to a human information recognition apparatus and method capable of recognizing identity, location and activity information of people.

### BACKGROUND OF THE INVENTION

In order that robots provide the required services to humans while living together with the humans in everyday environments, it is essential to provide the robots with the ability to interact with the humans in a manner similar to a way that the humans interact with one another. Therefore, an HRI (Human Robot Interaction) technology to handle the issue of the interaction between the humans and the robots is a technology that should be settled preferentially in the commercialization of intelligent robots and is a core technique for a successful industrialization of the intelligent robot.

The HRI technology is a technique to design/implement an interactive environment with a robotic system so that the humans and the robots can perform a cognitive and emotional interaction via a variety of communication channels. This HRI technology is primarily different from an HCI (Human-Computer Interaction) technology in view of autonomy exerted by a robot, bidirectional of the interaction, diversity of the interaction or control level and the like.

On the other hand, the HRI technology required by robot service developers is concentrated in an ability to recognize information relating to people based on video or audio signal mainly and needs to develop a precise 3W recognition technology among other thing. The 3W recognition technology refers to an identity recognition that recognizes Who is the user, a location recognition that recognizes Where is the user and an activity recognition that recognizes What action the user takes.

According to 3W recognition technology of a conventional art, there has been tried to recognize the humans under a collaborative environment using hardware only within the robot.

As such, with only the resource of the robot such as video cameras, microphones, processors mounted on the robot, it is difficult to cope effectively with a change in an illumination environment, a change in a posture of the user, a change in the distance between the user and the robot that occur frequently in a real environment. Therefore, research and technology for recognizing the user using only the sensors which are mounted on the robot would constrain the user or the environment in any form, which comes to a factor to lower the satisfaction degree of performance in a real environment.

Accordingly, the HRI technology has a problem that does not meet the performance, which is required by the robot service providers, such as the 3W recognition performance that exhibits a high reliability with respect to multiple users in a real environment.

### SUMMARY OF THE INVENTION

In view of the above, the present invention provides a human information recognition apparatus and method, which is capable of mixing multi-sensor resource and resources of the robot placed in a recognition space to provide 3W information with a high reliability under a situation in which many users exist together.

In accordance with a first aspect of the present invention, there is provided a human information recognition method including: analyzing sensor data from multi-sensor resource placed in a recognition space to generate human information based on the sensor data, the human information including an identity, location and activity information of people existed in the recognition space; mixing the human information based on the sensor data with human information provided from a mobile robot terminal placed in the recognition space, the human information being acquired through interaction with the people existed in the recognition space, depending on a location of the mobile robot terminal and a status of the interaction to generate mixed human information; and storing a human model of the people existed in the recognition space depending on the mixed human information in a database unit.

Further, the analyzing sensor data may comprise tracing a location of the people in images received from a number of camera among the multi-sensor resource.

Further, the analyzing sensor data may comprise yielding an actual location located in the recognition space for each person, in the format of a coordinate (x, y, z), with respect to the people who are traced in the images.

Further, the analyzing sensor data may comprise judging whether the person takes what posture and action from the images received from the number of cameras among the multi-sensor resource.

Further, the analyzing sensor data may comprise recognizing sound received from a number of microphones among the multi-sensor resource.

Further, the analyzing sensor data may comprise judging who are one whose identity is recognized on a priority basis depending on the human model that is already stored in the database unit.

Further, the analyzing sensor data may comprise recognizing the identity of the people using the images acquired by controlling a number of cameras among the multi-sensor resource.

Further, the human information recognition method may further comprise updating the human model in accordance with the mixed human information.

Further, the human information recognition method may further comprise storing in the database unit and managing a history that represents changes in the mixed human information with the lapse of the time with respect to the people who exist at present or who had existed in the recognition space.

In accordance with a second aspect of the present invention, there is provided a human information recognition apparatus including: a recognition information generation unit configured to analyze sensor data derived from a multi-sensor resource placed in a recognition space to generate human information based on the sensor data, the human information including identity, location and activity information of people existed in the recognition space; a mixing unit configured to mix the human information based on the sensor data with human information provided from a mobile robot terminal placed in the recognition space, the human information being acquired through interaction with the people existing in the recognition space, depending on a location of the mobile robot terminal and a status of the interaction to generate mixed human information; and a database unit that stores a human model of the people existed in the recognition space depending on the mixed human information.

Further, the recognition information generation unit may be configured to trace a location of the people in images received from a number of cameras among the multi-sensor resource.

Further, the recognition information generation unit may be configured to yield an actual location located in the recognition space for each person, in the format of a coordinate (x, y, z), with respect to the people who are traced in the images.

Further, the recognition information generation unit may comprise an activity recognizer that judges whether the person takes what posture and action from the images received from the number of cameras among the multi-sensor resource.

Further, the recognition information generation unit may comprise a sound recognizer that recognizes sound received from a number of microphones among the multi-sensor resource.

Further, the recognition information generation unit may comprise a context recognizer that judges who are one to attempt an identity recognition on a priority basis depending on the mixed human model that is already stored in the database unit.

Further, the recognition information generation unit may comprise an identity recognizer that recognizes the identity of the people using the images acquired by controlling a number of cameras among the multi-sensor resource.

Further, the human information recognition apparatus may further comprise a human model updating unit configured to update the human model in accordance with the mixed human information.

Further, the human information recognition apparatus may further comprise a history management unit configured to store in the database unit and manage a history that represents changes in the mixed human information with the lapse of the time with respect to the people who exist at present or who had existed in the recognition space the recognition space.

In accordance with an embodiment of the present invention, by mixing the multi-sensor resource and resources of the robot placed in a recognition space, it is possible to improve the reliability of the recognized information when recognizing the identity, location and activity information of the user under a situation in which many users exist together.

Further, it is possible to respond efficiently to the various changes in the illumination, in the posture of the user, in the distance between the robot and the user that may occur in a real environment.

Moreover, it is possible to stably provide a high-level 3W recognition information without being significantly affected by an appearance of the robot, portability, type and number of sensors mounted on the robot, and cognitive ability and others.

In addition, unlike the conventional arts that try to recognize sporadically using individual recognition modules at the time when recognition information is requested by a service application requests, the 3W information is continuously collected based on the continuous monitoring irrespective of the requested time point, which leads to a significant improvement of the recognition performance.

Consequently, in accordance with the present invention, by obtaining the 3W recognition information satisfactory to the robot service provider, it is also possible to provide a variety of application services relating to the robots. Moreover, the embodiment may be applied to not only intelligent robots, but also a wide range of field of digital home, smart space, and security.

### BRIEF DESCRIPTION OF THE DRAWINGS

The above and other objects and features of the present invention will become apparent from the following description of the embodiments given in conjunction with the accompanying drawings, in which:

FIG. 1 is a network diagram among a multi-sensor resource, a mobile robot terminal and a human information recognition apparatus in accordance with an embodiment of the present invention;

FIG. 2 is a block diagram of a human information recognition apparatus in accordance with an embodiment of the present invention;

FIG. 3 is a flow chart illustrating a human information recognition method performed by the human information recognition apparatus in accordance with an embodiment of the present invention; and

FIG. 4 is an illustrative view illustrating a user's location coordinate available in the human information recognition apparatus in accordance with an embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, the embodiments of the present invention will be described in detail with reference to the accompanying drawings.

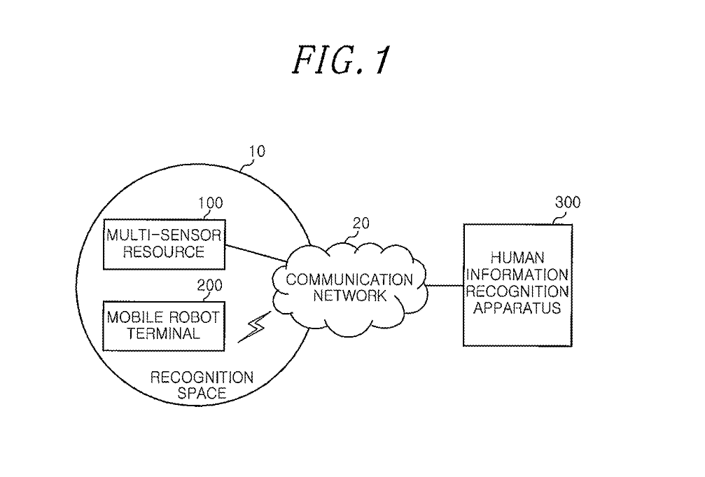

FIG. 1 is a network diagram among a multi-sensor resource, a mobile robot terminal and a human information recognition apparatus in accordance with an embodiment of the present invention.

As illustrated in FIG. 1, a multi-sensor resource 100 including a number of heterogeneous sensors and a mobile robot terminal 200 that are placed in a recognition space 10. The multi-sensor resource 100 and the mobile robot terminal 200 are connected with the human information recognition apparatus 300 through a communication network 20.

The term of “recognition space” used herein refers to all the spaces such as schools, silver towns, government and public offices and the like where the mobile robot terminal 200 can provide services. In addition, the term of “heterogeneous sensors” used herein refers to all the sensors capable of extracting information on the humans existing in the recognition space 10 such as cameras, microphones, distance sensors, RFID (Radio-Frequency Identification), etc.

A network in which the multi-sensor resource 100 and the mobile robot terminal 200 are associated with each other will be referred hereinafter to as a PSN (Perception Sensor Network).

The mobile robot terminal 200 directly interacts with people within the recognition space 10. The mobile robot terminal 200 analyzes data collected from its own sensors and performs 3W recognition on the people around the mobile robot terminal. The recognized 3W information is provided to the human information recognition apparatus 300.

The human information recognition apparatus 300 analyzes sensor data, which is received from the multi-sensor resource 100, and performs the 3W recognition on the people within the recognition space 10. The recognized 3W information is mixed with the 3W information provided from the mobile robot terminal 200 to enhance the reliability of recognized results.

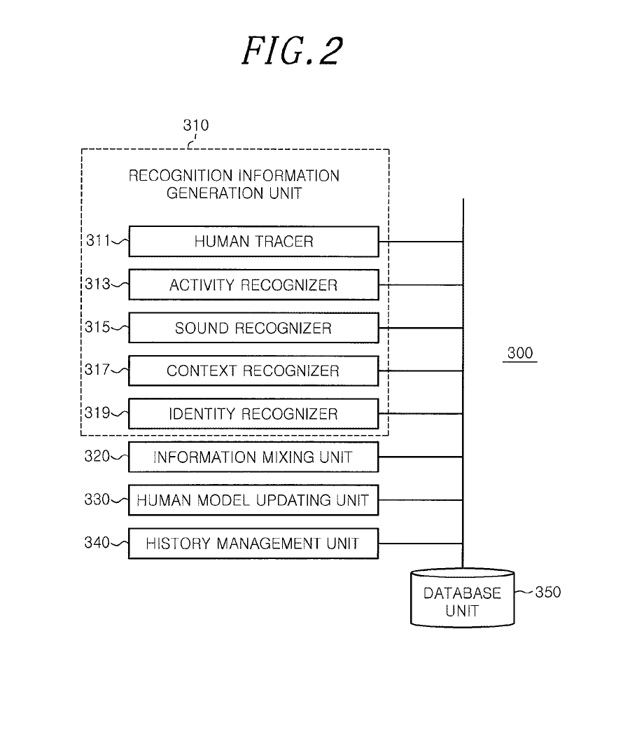

FIG. 2 is a block diagram of the human information recognition apparatus in accordance with an embodiment of the present invention.

As illustrated in FIG. 2, the human information recognition apparatus 300 includes a recognition information generation unit 310, information mixing unit 320, human model updating unit 330, history management unit 340 and database unit 350. The recognition information generation unit 310 includes a human tracer 311, activity recognizer 313, sound recognizer 315, context recognizer 317 and identity recognizer 319.

The recognition information generation unit 310 analyzes the sensor data derived from the multi-sensor resource placed in the recognition space to generate the human information based on the sensor data which includes identity, location and activity information of the people existed in the recognition space.

The human tracer 311 in the recognition information generation unit 310 traces the location of the people in the images received from a number of cameras. For the many peoples who are traced in the human tracer 311, an actual location of each person located in the recognition space is output in the format of a coordinate (x, y, z).

The activity recognizer 313 in the recognition information generation unit 310 judges whether each person takes what gesture and action in the images received from a plurality of cameras among the multi-sensor resource.

The sound recognizer 315 in the recognition information generation unit 310 recognizes sound received from a plurality of microphones among the multi-sensor resource.

The context recognizer 317 in the recognition information generation unit 310 judges who is one to attempt an identity recognition on a priority basis based on a human model that is stored beforehand in the database unit 350.

The identity recognizer 319 in the recognition information generation unit 310 recognizes the identity of the people using the images acquired by controlling a plurality of cameras among the multi-sensor resource.

The information mixing unit 320 in the recognition information generation unit 310 mixes the human information provided from the mobile robot terminal 200 that is acquired through interaction with the people and the human information based on the sensor data depending on the location of the mobile robot terminal and the status of the interaction, thereby creating mixed human information.

The human model updating unit 330 updates the human model in the database unit 350 depending on the mixed human information.

The history management unit 340 stores in the database unit 350 and manages a history that represents changes in the mixed human information with the lapse of the time with respect to the person who exist at present or who had existed in the recognition space.

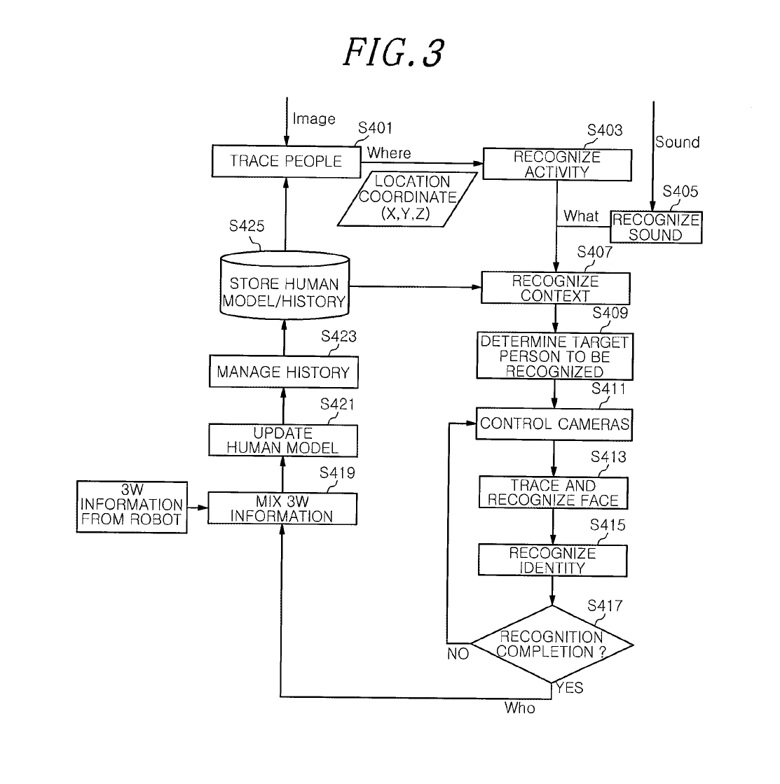

FIG. 3 is a flow chart illustrating a human information recognition method performed by the human information recognition apparatus in accordance with an embodiment of the present invention.

As illustrated in FIG. 3, the human information recognition method includes: analyzing sensor data from multi-sensor resource placed in a recognition space to generate human information based on the sensor data, the human information including an identity, location and activity information of people existed in the recognition space, in operations S401 to S417; mixing the human information based on the sensor data with human information provided from the mobile robot terminal placed in the recognition space, which is acquired through an interaction with the people existed in the recognition space, depending on the location of the mobile robot terminal and the status of the interaction, to generate mixed human information, in operation S419; storing in a database unit or managing a human model of the people existed in the recognition space depending on the mixed human information, in operation S421; and storing in the database unit and managing a history that represents changes in the mixed human information with the lapse of the time with respect to the people who exist at present or who had existed in the recognition space, in operation S423 and S425.

Hereinafter, the human information recognition method performed by the human information recognition apparatus in accordance with an embodiment of the present invention will be described with reference to FIGS. 1 to 4 in detail. Following description will be made under a situation where the sensor data from the cameras and microphones is analyzed for the sake of a simple explanation of the invention although the human information recognition apparatus of the embodiment may receive all kinds of sensor data from different heterogeneous sensors placed in the recognition space.

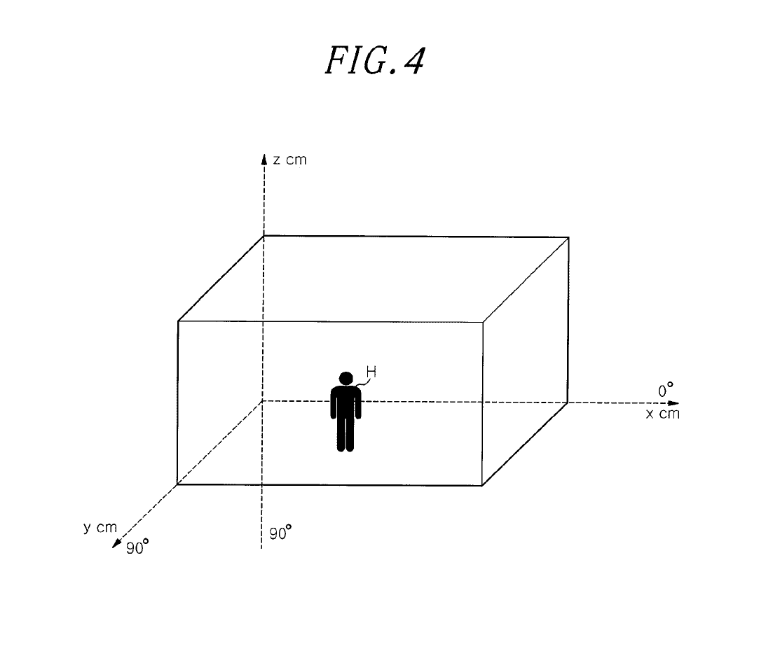

First, the human tracer 311 in the recognition information generation unit 310 traces the location of the people in the images received from a plurality of fixed cameras among the multi-sensor resource 100 installed in the recognition space 10 and outputs the location of each person in the recognition space in the format of a coordinate (x, y, z) with respect to the people, in operation S401. For example, a location coordinate of a person H may be yielded in the format of a coordinate (x, y, z) using a position coordinate system as illustrated in FIG. 4.

When a location of a person is traced in images captured by one camera or in a one-way, an issue of overlapped people may cause lowering the reliability of the trace. However, the human tracer 311 utilizes a number of cameras and thus effectively solves the issue of the overlapped people. Further, since a particular person may be appeared repeatedly in the images acquired from a number of cameras, a high reliability of the trace can be secured by complementing the traced results each other.

When the location recognition is completed by the human tracer 311, the activity recognizer 313 in the recognition information generation unit 310 judges whether each person takes what gesture and action from the images received from a plurality of fixed cameras, in operation S403. For example, it is judged that standing posture, sitting posture, lying posture, action to walk, action to run, and action to raise a hand. As similar to the human tracer 311, the activity recognizer 313 also utilizes the images that are obtained from the plurality of cameras, thereby improving the reliability of the trace.

Next, the sound recognizer 315 in the recognition information generation unit 310 recognizes sound received from a plurality of microphones among the multi-sensor resource 100 installed in the recognition space 10, and sound status information perceived through the sound recognition is provided to the context recognizer 317, in operation S405.

Subsequently, the context recognizer 317 in the recognition information generation unit 310 judges who is one to attempt an identity recognition on a priority basis based on different information such as the location recognition information obtained by the human tracer 311, the activity recognition information obtained by the activity recognizer 313, the sound recognition information obtained by the sound recognizer 315, the human model that is stored in advance in the database unit the database unit 350, and the 3W history information that is accumulated, in operation S407 and S409.

Scenarios that the context recognizer 317 is able to recognize may be as follows:

Scenario 1: Is there at present a person whose identity has not been recognized yet?

Scenario 2: There is conducted an identity recognition, but is there a person whose recognition confidence is low?

Scenario 3: Is there a person whose identification number of trials are significantly low compared to others?

Scenario 4: Is there a person who was overlapped and separated?

Scenario 5: Is there a person who is taking the unusual behavior (lying, raising hands, running, etc.)?

Scenario 6: Is there a person who directly interacts with the robot at present?

Scenario 7: Is there a person who is talking with or speaking loud (applauding, screaming, etc.)?

Scenario 8: Is there a person who is taking with a cooperative stance friendly to recognize the identity?

Scenario 9: Is there a person who has been specified by the request of the external application?

Of course, it may be possible to add other scenarios than those listed in the scenarios 1 to 9, which need be perceived, based on the characteristics of the recognition space 10.

When a target person whose identity is recognized is determined, the identity recognizer 319 in the recognition information generation unit 310 moves all the cameras that belong to the multi-sensor resource 100 toward the direction where the target person to be recognized is sited, in operation S411. Further, all the cameras are zoomed-in so that the size of a face in the images comes to be a predetermined size (for example, 100×100 pixels or more) or larger by using the distance information between the target person and the cameras. This is to ensure a face image of high resolution having the size profitable to a face recognition. Thereafter, a continuous image is acquired while tracing the face of the target person using the cameras, and the face of the target person is recognized using the acquired continuous images, in operation S413. Further, the face recognition information is combined in conjunction with information that recognizes external characteristics (e.g., dress color, hair color, height, etc.) other than the face to recognize the identity of the target person, in operation S415.

When the identity recognition by the identity recognizer 319 is completed in operation S417, the human information based on the sensor data, which includes the identity, location and activity information of the person existed in the recognition space 10 is then provided to the information mixing unit 320. The information mixing unit 320 mixes the human information based on the sensor data which is the 3W information that is acquired through the analysis of the sensor data from the multi-sensor resource 100 with the human information which is the 3W information acquired by the mobile robot terminal 200 to create the mixed human information, in operation S419.

In this regard, the mobile robot terminal 200 may easily acquire a front face image of a user who directly interacts with the mobile robot terminal 200 and is cooperative. Thus, the 3W information recognized by the mobile robot terminal 200 may be more reliable than the 3W information recognized by processing the sensor data from the multi-sensor resource 100. Therefore, the information mixing unit 320 may enhance the recognition performance by mixing the 3W information that is acquired through the analysis of the sensor data from the multi-sensor resource 100 and the 3W information that is acquired by the mobile robot terminal 200 depending on the location of the mobile robot terminal 200 and the status of interaction between the users and the mobile robot terminal. For example, when the level of the interaction between the mobile robot terminal 200 and the users is higher than a predetermined level, the human information provided from the mobile robot terminal has a priority; otherwise, when the level of the interaction between the mobile robot terminal and the users is not higher than the predetermined level, the sensor data based human information has a priority.

The human model updating unit 330 stores in the database unit 350 or updates the 3W model of the people existed in the recognition space 10. In this case, with respect to all the people who had existed in the recognition space 10, current location and activity information for each person is updated. Further, with respect to the people whose identity has been recognized, recognition similarity information is also accumulated. Further, when a person newly appears in the recognition space the recognition space 10, a new model is generated and given, and when a person exits in the recognition space, a his/her model might be usable; and, therefore, is not immediately deleted from the database unit the database unit 350, but maintained in the database unit 350 for a period of time, in operation S421.

The history management unit 340 manages the 3W history information with the lapse of time with respect to the person who exists at present or who had existed in the recognition space 10. For example, the history management unit 340 manages such information on when a particular person has appeared, what kinds of behavior patterns were taken by the person, and when the person performs how to interact with the mobile robot terminal 200, in operation S423.

The database unit 350 stores the human model and the 3W history information for each person. The human information and the 3W history information are utilized in the human tracer 311 and the context recognizer 317, and are provided to service applications or the like that requires the 3W information through an external interface (not shown), in operation S425.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A human information recognition method comprising:
analyzing sensor data from multi-sensor resource placed in a recognition space to generate human information based on the sensor data, the human information including an identity, location and activity information of people existed in the recognition space;
mixing the human information based on the sensor data with human information provided from a mobile robot terminal placed in the recognition space, the human information being acquired through interaction with the people existed in the recognition space, depending on a location of the mobile robot terminal and a status of the interaction to generate mixed human information; and
storing a human model of the people existed in the recognition space depending on the mixed human information in a database unit.

2. The human information recognition method of claim 1, wherein said analyzing sensor data comprises:
tracing a location of the people in images received from a number of camera among the multi-sensor resource.

3. The human information recognition method of claim 2, wherein said analyzing sensor data comprises:
yielding an actual location located in the recognition space for each person, in the format of a coordinate (x, y, z), with respect to the people who are traced in the images.

4. The human information recognition method of claim 1, wherein said analyzing sensor data comprises:
judging whether the person takes what posture and action from the images received from the number of cameras among the multi-sensor resource.

5. The human information recognition method of claim 1, wherein said analyzing sensor data comprises:
recognizing sound received from a number of microphones among the multi-sensor resource.

6. The human information recognition method of claim 1, wherein said analyzing sensor data comprises:
judging who are one whose identity is recognized on a priority basis depending on the human model that is already stored in the database unit.

7. The human information recognition method of claim 1, wherein said analyzing sensor data comprises:
recognizing the identity of the people using the images acquired by controlling a number of cameras among the multi-sensor resource.

8. The human information recognition method of claim 1, further comprising:
updating the human model in accordance with the mixed human information.

9. The human information recognition method of claim 1, further comprising:
storing in the database unit and managing a history that represents changes in the mixed human information with the lapse of the time with respect to the people who exist at present or who had existed in the recognition space.

10. A human information recognition apparatus comprising:
a recognition information generation unit configured to analyze sensor data derived from a multi-sensor resource placed in a recognition space to generate human information based on the sensor data, the human information including identity, location and activity information of people existed in the recognition space;
a mixing unit configured to mix the human information based on the sensor data with human information provided from a mobile robot terminal placed in the recognition space, the human information being acquired through interaction with the people existing in the recognition space, depending on a location of the mobile robot terminal and a status of the interaction to generate mixed human information; and
a database unit that stores a human model of the people existed in the recognition space depending on the mixed human information.

11. The human information recognition apparatus of claim 10, wherein the recognition information generation unit is configured to trace a location of the people in images received from a number of cameras among the multi-sensor resource.

12. The human information recognition apparatus of claim 11, wherein the recognition information generation unit is configured to yield an actual location located in the recognition space for each person, in the format of a coordinate (x, y, z), with respect to the people who are traced in the images.

13. The human information recognition apparatus of claim 10, wherein the recognition information generation unit comprises an activity recognizer that judges whether the person takes what posture and action from the images received from the number of cameras among the multi-sensor resource.

14. The human information recognition apparatus of claim 10, wherein the recognition information generation unit comprises a sound recognizer that recognizes sound received from a number of microphones among the multi-sensor resource.

15. The human information recognition apparatus of claim 10, wherein the recognition information generation unit comprises a context recognizer that judges who are one to attempt an identity recognition on a priority basis depending on the mixed human model that is already stored in the database unit.

16. The human information recognition apparatus of claim 10, wherein the recognition information generation unit comprises an identity recognizer that recognizes the identity of the people using the images acquired by controlling a number of cameras among the multi-sensor resource.

17. The human information recognition apparatus of claim 10, further comprising:
a human model updating unit configured to update the human model in accordance with the mixed human information.

18. The human information recognition apparatus of claim 10, further comprising:
a history management unit configured to store in the database unit and manage a history that represents changes in the mixed human information with the lapse of the time with respect to the people who exist at present or who had existed in the recognition space the recognition space.
